(19) United States
(12) Patent Application Publication
(10) Pub. No.: US 2025/0051632 A1
(43) Pub. Date: Feb. 13, 2025

(54) COMPOSITIONS AND METHODS FOR DISSOLVING IRON SULFIDE

(71) Applicant: ECOLAB USA Inc., St. Paul, MN (US)

(72) Inventors: Carter Martin SILVERNAIL, Lakeville, MN (US); Ashish DHAWAN, Aurora, IL (US); Emily Rebecca WOOD, Naperville, IL (US)

(73) Assignee: ECOLAB USA Inc., St. Paul, MN (US)

(21) Appl. No.: 18/797,326

(22) Filed: Aug. 7, 2024

Related U.S. Application Data
(60) Provisional application No. 63/518,500, filed on Aug. 9, 2023.

(51) Int. Cl. C09K 8/532

(52) U.S. Cl. CPC C09K 8/532

(57) ABSTRACT

The present disclosure provides methods and compositions for dissolving iron sulfide deposits in aqueous systems. A method may include adding a composition to the aqueous medium. The composition may include a polycarboxylate polymer and/or a salt thereof. The composition may optionally include a solvent and/or an additive. The compositions and methods may be used for dissolving typical insoluble inorganic salts encountered in the oil and gas, recovery, water, and processing industries.

### TECHNICAL FIELD

The present disclosure provides compositions and methods for removing oilfield hydrocarbon and iron sulfide based deposits from equipment.

### BACKGROUND

As oilfields age, the amount of oil produced decreases and the amount of water produced with the oil increases. The water is usually disposed of or injected back into the formation to maintain reservoir pressure. The separation process is efficient, but not perfect, and a small fraction of oil and other debris can be present after the fluids pass through the separation equipment. That residual fraction of oil in water carryover can cause significant problems as the field ages.

Fields can produce as much as 1,000,000 barrels of water each day. The residual oil and other particles, such as paraffin, asphaltenes, iron sulfide and biomass can build up in the separation equipment and pipelines. If left untreated, this form of deposition can plug lines, which can lead to loss of revenue and/or equipment failure. Due to lines which cannot be mechanically cleaned, a chemical solution is needed that can be injected into the system to maintain control of the deposition in the lines.

In addition to plugging lines, deposits comprising iron sulfide may collect on internal surfaces. Such unwanted deposits may be complex mixtures of inorganic compounds, such as sand and iron sulfide, and organic compounds, such as asphaltenes and crude petroleum. The deposits are sticky and difficult to clean. Currently available cleaners for removing deposits from equipment used in oil and gas applications aid in the removal of the organic deposition but are less effective against the inorganic deposition, especially iron sulfide. Conventional cleaners may disperse iron sulfide, but are relatively ineffective in inhibiting or dissolving iron sulfide, providing only limited cleaning ability. Conventional cleaners may also be acidic and therefore incompatible with the metallurgy of the systems they are designed to treat.

### BRIEF SUMMARY

In certain aspects, the present disclosure provides a method of dissolving an iron sulfide deposit in an aqueous medium. The method comprises adding a composition comprising a polycarboxylate polymer to the aqueous medium, and dissolving at least a portion of the iron sulfide deposit.

In some embodiments, the composition comprises about 0.1 wt. % to about 60 wt. % of the polycarboxylate polymer.

In some embodiments, the polycarboxylate polymer is an acrylic acid homopolymer, an acrylic acid copolymer, a maleic acid homopolymer, a maleic acid copolymer, or any combination thereof. In certain embodiments, the polycarboxylate polymer is a copolymer comprising acrylic acid and maleic acid. In some embodiments, the polycarboxylate polymer is at least partially neutralized. In some embodiments, the polycarboxylate polymer is phosphonate terminated.

The method may further comprise increasing a soluble iron percentage in the aqueous medium. For example, the soluble iron percentage may be increased by about 5% to about 100%.

In some embodiments, the aqueous medium comprises a chloride-containing salt. In some embodiments, the chloride-containing salt is sodium chloride, calcium chloride, magnesium chloride, potassium chloride, or a combination thereof. In certain embodiments, the aqueous medium comprises sodium bicarbonate, sodium bromide, or a combination thereof. In some embodiments, the aqueous medium comprises water, a gas, a liquid hydrocarbon, or any combination thereof.

In some embodiments, the composition further comprises an additive selected from the group consisting of an asphaltene inhibitor, a solvent, a paraffin inhibitor, a scale inhibitor, an emulsifier, a water clarifier, a dispersant, an emulsion breaker, a hydrogen sulfide scavenger, a gas hydrate inhibitor, a biocide, a pH modifier, an antifoam, a surfactant, a chelating agent, a hydroxycarboxylic acid, a sugar acid, malic acid, a corrosion inhibitor, and any combination thereof.

In certain embodiments, a surface in contact with the aqueous medium comprises the iron sulfide deposit.

In some embodiments, the composition consists of or consists essentially of the polycarboxylate polymer. In some embodiments, the composition consists of or consists essentially of the polycarboxylate polymer and the additive. In certain embodiments, the composition consists of or consists essentially of the polycarboxylate polymer and the solvent.

In some embodiments, the method further comprises adding the polycarboxylate polymer at a concentration of about 5 ppm to about 20,000 ppm.

The present disclosure also provides a method of dissolving an iron sulfide deposit in an aqueous medium. The method comprises providing a composition comprising about 0.1 wt. % to about 60 wt. % of a polycarboxylate polymer, adding the composition to the aqueous medium, the aqueous medium comprising water, a gas, a liquid hydrocarbon, or any combination thereof, wherein a surface in contact with the aqueous medium comprises the iron sulfide deposit, and dissolving at least a portion of the iron sulfide deposit.

In some embodiments, the polycarboxylate polymer is added at a concentration of about 5 ppm to about 20,000 ppm. In some embodiments, the polycarboxylate polymer is an acrylic acid homopolymer, an acrylic acid copolymer, a maleic acid homopolymer, a maleic acid copolymer, or any combination thereof. In certain embodiments, the polycarboxylate polymer is a copolymer comprising acrylic acid and maleic acid. In some embodiments, the polycarboxylate polymer is at least partially neutralized. In some embodiments, the polycarboxylate polymer is phosphonate terminated.

The method may further comprise increasing a soluble iron percentage in the aqueous medium. For example, the soluble iron percentage may be increased by about 5% to about 100%.

In some embodiments, the aqueous medium comprises a chloride-containing salt. In some embodiments, the chloride-containing salt is sodium chloride, calcium chloride, magnesium chloride, potassium chloride, or a combination thereof. In certain embodiments, the aqueous medium comprises sodium bicarbonate, sodium bromide, or a combination thereof.

In some embodiments, the composition further comprises an additive selected from the group consisting of an asphaltene inhibitor, a solvent, a paraffin inhibitor, a scale inhibitor, an emulsifier, a water clarifier, a dispersant, an emulsion breaker, a hydrogen sulfide scavenger, a gas hydrate inhibitor, a biocide, a pH modifier, an antifoam, a surfactant, a chelating agent, a hydroxycarboxylic acid, a sugar acid, malic acid, a corrosion inhibitor, and any combination thereof.

In some embodiments, the composition consists of or consists essentially of the polycarboxylate polymer. In certain embodiments, the composition consists of or consists essentially of the polycarboxylate polymer and the additive. In some embodiments, the composition consists of or consists essentially of the polycarboxylate polymer and the solvent.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 shows the results of an iron sulfide dissolution test conducted in DI water;

FIG. 2 shows the results of an iron sulfide dissolution test conducted in sea salt water;

FIG. 3 shows the results of an iron sulfide dissolution test conducted in 3% KCl brine; and

FIG. 4 shows the results of an iron sulfide dissolution test conducted in synthetic brine.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

“Oxo” refers to an oxygen atom double-bonded to a carbon atom.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions for removing iron sulfide deposits in oil and gas processes. In some embodiments, a composition comprises an iron sulfide dissolver, such as a polycarboxylate polymer and/or a salt thereof, which may be used to dissolve iron sulfide. Compositions disclosed herein may optionally comprise other components, such as an additive and/or a solvent (e.g., an organic solvent). In some embodiments, the compositions disclosed herein exclude a solvent, an additive, such as a corrosion inhibitor, and/or phosphorous.

The compositions disclosed herein are useful in crude oil-based and natural gas-based products, processes, and refinery streams. The compositions are useful for removing hydrocarbonaceous deposits from metallic and/or mineral surfaces in contact with a fluid in oil and gas applications, including removal of iron sulfide to reduce the risk of corrosion failures due to under deposit corrosion. The compositions can be used in sweet systems (i.e., systems having a relatively high carbon dioxide concentration) or in systems having sour conditions (i.e., relatively high hydrogen sulfide concentration). The compositions are useful in a wide range of climates and under a wide range of process conditions, such as from about 0° C. to about 200° C., where other available cleaner compositions fail.

The iron sulfide dissolver comprises a polycarboxylate polymer.

In some embodiments, the polycarboxylate polymer is an acrylic acid homopolymer, an acrylic acid copolymer, a maleic acid homopolymer, a maleic acid copolymer, or any combination thereof.

The acrylic acid copolymer may comprise an additional monomer selected from the group consisting of maleic acid, fumaric acid, itaconic acid, and any combination thereof.

The acrylic acid copolymer may comprise from about 1 mol % to about 99 mol % of the acrylic acid monomer and from about 99 mol % to about 1 mol % of the co-monomer(s). For example, the acrylic acid copolymer may comprise from about 5 mol % to about 99 mol %, about 10 mol % to about 99 mol %, about 15 mol % to about 99 mol %, about 20 mol % to about 99 mol %, about 25 mol % to about 99 mol %, about 30 mol % to about 99 mol %, about 35 mol % to about 99 mol %, about 40 mol % to about 99 mol %, about 45 mol % to about 99 mol %, about 50 mol % to about 99 mol %, about 55 mol % to about 99 mol %, about 60 mol % to about 99 mol %, about 65 mol % to about 99 mol %, about 70 mol % to about 99 mol %, about 75 mol % to about 99 mol %, about 80 mol % to about 99 mol %, about 85 mol % to about 99 mol %, about 90 mol % to about 99 mol %, about 95 mol % to about 99 mol %, about 5 mol % to about 90 mol %, about 10 mol % to about 80 mol %, about 20 mol % to about 70 mol %, about 30 mol % to about 60 mol %, about 40 mol % to about 60 mol %, or about 50 mol % of the acrylic acid monomer and/or the co-monomer(s).

The maleic acid copolymer may comprise an additional monomer selected from the group consisting of acrylic acid, methacrylic acid, crotonic acid, isocrotonic acid, and any combination thereof.

The maleic acid copolymer may comprise from about 1 mol % to about 99 mol % of the maleic acid monomer and from about 99 mol % to about 1 mol % of the co-monomer(s). For example, the acrylic acid copolymer may comprise from about 5 mol % to about 99 mol %, about 10 mol % to about 99 mol %, about 15 mol % to about 99 mol %, about 20 mol % to about 99 mol %, about 25 mol % to about 99 mol %, about 30 mol % to about 99 mol %, about 35 mol % to about 99 mol %, about 40 mol % to about 99 mol %, about 45 mol % to about 99 mol %, about 50 mol % to about 99 mol %, about 55 mol % to about 99 mol %, about 60 mol % to about 99 mol %, about 65 mol % to about 99 mol %, about 70 mol % to about 99 mol %, about 75 mol % to about 99 mol %, about 80 mol % to about 99 mol %, about 85 mol % to about 99 mol %, about 90 mol % to about 99 mol %, about 95 mol % to about 99 mol %, about 5 mol % to about 90 mol %, about 10 mol % to about 80 mol %, about 20 mol % to about 70 mol %, about 30 mol % to about 60 mol %, about 40 mol % to about 60 mol %, or about 50 mol % of the maleic acid monomer and/or the co-monomer(s).

In certain aspects of the present disclosure, the polycarboxylate polymer is a copolymer comprising acrylic acid and maleic acid.

The polycarboxylate polymer disclosed herein may be fully neutralized, partially neutralized, or not neutralized at all. In certain aspects, the polycarboxylate polymer is phosphonate terminated.

The weight average molecular weight of the polycarboxylate polymer disclosed herein is not particularly limited. In some embodiments, the polycarboxylate polymer comprises a molecular weight of about 500 Da to about 100,000 Da. For example, the molecular weight may be from about 500 Da to about 80,000 Da, from about 500 Da to about 60,000 Da, from about 500 Da to about 40,000 Da, from about 500 Da to about 20,000 Da, from about 500 Da to about 10,000 Da, from about 1,000 Da to about 80,000 Da, from about 5,000 Da to about 80,000 Da, from about 15,000 Da to about 80,000 Da, from about 25,000 Da to about 80,000 Da, from about 35,000 Da to about 80,000 Da, from about 45,000 Da to about 80,000 Da, from about 55,000 Da to about 80,000 Da, from about 1,000 Da to about 50,000 Da, from about 1,000 Da to about 40,000 Da, or from about 2,000 Da to about 45,000 Da.

The iron sulfide dissolver may optionally comprise a multi-functional hydroxy-carboxylic acid and/or additional components, such as allaric acid, altaric acid, altraric acid, altronic acid, arabinaric acid, arabinonic acid, citric acid, dihomocitric acid, fructuronic acid, fuconic acid, fumaric acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, xyluronic acid, tartaric acid, tatronic acid, glyceric acid, malonic acid and pantoic acid, a salt of any of these acids, or any combination thereof.

Suitable salts of the iron sulfide dissolver include alkali metal and alkaline earth metal salts, such as sodium, potassium, lithium, magnesium, calcium and cesium salts. The iron sulfide dissolver inhibits the formation of iron sulfide and/or dissolves iron sulfide.

The iron sulfide dissolver may be present in a composition in an amount ranging from about 0.1 wt. % to about 100 wt. %, such as from about 0.1 wt. % to about 90 wt. %, about 0.1 wt. % to about 80 wt. %, about 0.1 wt. % to about 70 wt. %, about 0.1 wt. % to about 60 wt. %, about 0.1 wt. % to about 50 wt. %, about 0.1 wt. % to about 40 wt. %, about 0.1 wt. % to about 30 wt. %, about 0.1 wt. % to about 20 wt. %, about 0.1 wt. % to about 10 wt. %, about 5 wt. % to about 100 wt. %, about 10 wt. % to about 100 wt. %, about 20 wt. % to about 100 wt. %, about 30 wt. % to about 100 wt. %, about 40 wt. % to about 100 wt. %, about 1 wt. % to about 100 wt. %, about 1 wt. % to about 75 wt. %, about 1 wt. % to about 50 wt. %, about 1 wt. % to about 25 wt. %, or about 5 wt. % to about 40 wt. %, based on total weight of the composition.

The compositions disclosed herein may optionally include an additive. Suitable additives include, but are not limited to, a solvent, an asphaltene inhibitor, a paraffin inhibitor, a scale inhibitor, an emulsifier, a water clarifier, a dispersant, an emulsion breaker, a hydrogen sulfide scavenger, a sulfur-containing compound, a gas hydrate inhibitor, a biocide, an antifoam, a pH modifier, a corrosion inhibitor and/or a surfactant.

A composition disclosed herein may comprise from about 0.1 wt. % to about 99 wt. %, from about 0.1 wt. % to about 90 wt. %, from about 0.1 wt. % to about 80 wt. %, from about 0.1 wt. % to about 70 wt. %, from about 0.1 wt. % to about 60 wt. %, from about 0.1 wt. % to about 50 wt. %, from about 0.1 wt. % to about 40 wt. %, from about 0.1 wt. % to about 30 wt. %, from about 0.1 wt. % to about 20 wt. %, from about 0.1 wt. % to about 10 wt. %, from about 0.1 wt. % to about 5 wt. %, or from about 0.5 wt. % to about 3 wt. % of the additive or any combination of additives.

Suitable corrosion inhibitors include, but are not limited to, alkyl, hydroxyalkyl, alkylaryl, arylalkyl or arylamine quaternary salts, mono or polycyclic aromatic amine salts, imidazoline derivatives, mono-, di- or trialkyl or alkylaryl phosphate esters, phosphate esters of hydroxylamines, phosphate esters of polyols, an ester of alcoholamine, an alkoxylated amine and/or monomeric and/or oligomeric fatty acids.

In some embodiments, the corrosion inhibitor comprises an imidazoline. The imidazoline may be, for example, imidazoline derived from a diamine, such as ethylene diamine (EDA), diethylene triamine (DETA), triethylene tetraamine (TETA), etc., and a long chain fatty acid, such as tall oil fatty acid (TOFA).

In some embodiments, the compositions disclosed herein may include a sulfur-containing compound. If present, the sulfur-containing compound can be included in an amount of about 0.1 wt. % to about 25 wt. %, about 0.5 wt. % to about 20 wt. %, about 1 wt. % to about 10 wt. %, or about 1 wt. % to about 5 wt. %, based on total weight of the composition. The sulfur-containing compound may constitute about 0.1, about 0.5, about 1, about 2, about 3, about 4, about 5, about 6, about 7, about 8, about 9, about 10, about 11, about 12, about 13, about 14, about 15, about 16, about 17, about 18, about 19 or about 20 wt. % of the composition, based on total weight of the composition.

Suitable sulfur-containing compounds include, but are not limited to, compounds that enhance the corrosion inhibiting and/or cleaning performance of the composition. The sulfur-containing compound may include, for example, thioglycolic acid, 3,3′-dithiodipropionic acid, thiourea, 2-mercaptoethanol, L-cysteine, tert-butyl mercaptan, sodium thiosulfate, ammonium thiosulfate, sodium thiocyanate, ammonium thiocyanate, sodium metabisulfite, or any combination thereof. In some embodiments, the sulfur-containing compound is 2-mercaptoethanol.

Suitable asphaltene inhibitors include, but are not limited to, aliphatic sulfonic acids, alkyl aryl sulfonic acids, aryl sulfonates, lignosulfonates, alkylphenol/aldehyde resins and/or similar sulfonated resins, polyolefin esters, polyolefin imides, polyolefin esters with alkyl, alkylenephenyl or alkylenepyridyl functional groups, polyolefin amides, polyolefin amides with alkyl, alkylenephenyl or alkylenepyridyl functional groups, polyolefin imides with alkyl, alkylenephenyl or alkylenepyridyl functional groups, alkenyl/vinyl pyrrolidone copolymers, graft polymers of polyolefins with maleic anhydride or vinyl imidazole, hyperbranched polyester amides, polyalkoxylated asphaltenes, amphoteric fatty acids, salts of alkyl succinates, sorbitan monooleate, and polyisobutylene succinic anhydride.

Suitable paraffin inhibitors include, but are not limited to, paraffin crystal modifiers and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes.

Suitable scale inhibitors include, but are not limited to, phosphates, phosphate esters, phosphoric acids, phosphonates, phosphonic acids, polyacrylam ides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers, such as diallyldimethylammonium chloride (DADMAC).

Suitable dispersants include, but are not limited to, aliphatic phosphonic acids with 2-50 carbons, such as hydroxyethyl diphosphonic acid, and aminoalkyl phosphonic acids, e.g., polyaminomethylene phosphonates with 2-10 N atoms, each bearing at least one methylene phosphonic acid group, examples of the latter including ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersants include lignin, or derivatives of lignin, such as lignosulfonate and naphthalene sulfonic acid and derivatives. In some embodiments, a dispersant is selected from dodecyl benzene sulfonate, an oxyalkylated alkylphenol, and/or an oxyalkylated alkylphenolic resin.

Suitable emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, and resins, such as phenolic and epoxide resins.

Suitable hydrogen sulfide scavengers include, but are not limited to, oxidants (e.g., inorganic peroxides, such as sodium peroxide or chlorine dioxide); aldehydes (e.g., of 1-10 carbons, such as formaldehyde, glyoxal, glutaraldehyde, acrolein, or methacrolein; and triazines (e.g., monoethanolamine triazine, monomethylamine triazine, and triazines from multiple amines or mixtures thereof).

Suitable gas hydrate inhibitors include, but are not limited to, thermodynamic hydrate inhibitors, kinetic hydrate inhibitors, and anti-agglomerates. Suitable thermodynamic hydrate inhibitors include, but are not limited to, sodium chloride, potassium chloride, calcium chloride, magnesium chloride, sodium bromide, formate brines (e.g., potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, and triglycerol), sugar alcohols (e.g., sorbitol and mannitol), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

Suitable kinetic hydrate inhibitors and anti-agglomerates include, but are not limited to, polymers and copolymers, polysaccharides (such as hydroxyethylcellulose, carboxymethylcellulose, starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, and alkyl amido betaines), hydrocarbon-based dispersants (such as lignosulfonates, iminodisuccinates, and polyaspartates), amino acids, and proteins.

Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. For example, a pH modifier may include sodium hydroxide, potassium hydroxide, calcium hydroxide, calcium oxide, sodium carbonate, potassium carbonate, sodium bicarbonate, potassium bicarbonate, magnesium oxide, and magnesium hydroxide. In some embodiments, a pH modifier may comprise a hydrophilic or amphiphilic amine, such as methyldiethanolamine (MDEA).

Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono- and dialkyl sulfosuccinates and sulfosuccinamates. Nonionic surfactants include, but are not limited to, alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoxyl polyethylene glycol esters and diesters. Also included are betaines and sultanes, amphoteric surfactants, such as alkyl amphoacetates and amphodiacetates, alkyl amphopropionates and amphodipropionates, and alkyliminodipropionate.

The surfactant may be a quaternary ammonium compound, an amine oxide, an ionic or nonionic surfactant, or any combination thereof. Suitable quaternary ammonium compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhexyl) dimethyl quaternary ammonium methyl sulfate.

Suitable solvents include, but are not limited to, an alcohol, a hydrocarbon, a ketone, an ether, an alkylene glycol, a glycol ether, an amide, a nitrile, a sulfoxide, an ester, and water. The solvent may comprise water, isopropanol, methanol, ethanol, 2-ethylhexanol, heavy aromatic naphtha, toluene, ethylene glycol, ethylene glycol monobutyl ether, diethylene glycol monoethyl ether, and/or xylene.

The solvent may be a polar solvent, such as water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), an alkylene glycol (such as methylene glycol, ethylene glycol, 1,2-propylene glycol, 1,3-propylene glycol, etc.), a glycol ether (such as diethyleneglycol monomethyl ether, ethylene glycol monobutyl ether, ethylene glycol dibutyl ether, etc.), a ketone (such as cyclohexanone or diisobutylketone), an ether (such as diethyl ether), an alkylene carbonate (such as propylene carbonate), N-methylpyrrolidinone (NMP), N,N-dimethylformamide, a polyol (such as glycerin), and the like.

Illustrative, non-limiting examples of non-polar solvents suitable for formulation with the composition include, but are not limited to, aliphatic hydrocarbons, such as pentane, hexane, cyclohexane, methylcyclohexane, heptane, decane, dodecane, diesel, and the like; aromatic hydrocarbons, such as toluene, xylene, and heavy aromatic naphtha; and fatty acid derivatives, such as acids, esters, and amides.

The solvent may be compatible with an arctic environment. For example, methanol, ethanol, ethylene glycol or glycerin improve the anti-freeze properties of the composition. Such solvent is typically present in an amount of about 5 wt. % to about 15 wt. %, such as about 10 wt. %, based on total weight of the composition to have an anti-freeze effect.

In some embodiments, a composition disclosed herein comprises the following Formula 1:

| Product ID | Weight (%) | Chemistry description |
|---|---|---|
| Formula 1 | About 45% | Acrylic acid homopolymer (fully neutralized) |
| | About 55% | Water |

In some embodiments, a composition disclosed herein comprises the following Formula 2:

| Product ID | Weight (%) | Chemistry description |
|---|---|---|
| Formula 2 | About 50% | Acrylic acid/maleic acid copolymer (fully |
| | | neutralized, phosphonate terminated) |
| | About 50% | Water |

In some embodiments, a composition disclosed herein comprises the following Formula 3:

| Product ID | Weight (%) | Chemistry description |
|---|---|---|
| Formula 3 | About 35% | Acrylic acid/maleic acid copolymer (fully |
| | | neutralized) |
| | About 65% | Water |

In some embodiments, a composition disclosed herein comprises the following Formula 4:

| Product ID | Weight (%) | Chemistry description |
|---|---|---|
| Formula 4 | About 50% | Maleic acid homopolymer |
| | About 50% | Water |

In some embodiments, a composition disclosed herein comprises the following Formula 5:

| Product ID | Weight (%) | Chemistry description |
|---|---|---|
| Formula 5 | About 50% | Acrylic acid/maleic acid copolymer |
| | About 50% | Water |

In some embodiments, a composition disclosed herein comprises the following Formula 6:

| Product ID | Weight (%) | Chemistry description |
|---|---|---|
| Formula 6 | About 48% | Acrylic acid homopolymer |
| | About 52% | Water |

In some embodiments, a composition disclosed herein comprises the following Formula 7:

| Product ID | Weight (%) | Chemistry description |
|---|---|---|
| Formula 7 | About 50% | Hydrolyzed polymaleic acid |
| | About 50% | Water |

In some embodiments, the compositions disclosed herein consist of or consist essentially of any component (or combination of components) disclosed in Formulae 1 to 7.

In some embodiments, compositions of the present disclosure may be prepared by combining the iron sulfide dissolver with a solvent to form a solution. If desired, additional components, such as a solvent and/or an additive may be added to the solution.

The compositions of the present disclosure may be used for dissolving iron sulfide and/or removing hydrocarbonaceous deposits in oil and gas applications. The compositions may be used in any industry where it is desirable to dissolve iron sulfide and/or remove hydrocarbonaceous deposits from a surface.

In some embodiments, the present disclosure provides a method of dissolving an iron sulfide deposit in an aqueous system. The method comprises adding a composition to the aqueous medium, wherein the composition comprises a polycarboxylate polymer and/or a salt thereof. In some embodiments, the present disclosure provides a method of inhibiting corrosion of a metallic surface in an aqueous system. The method comprises adding a composition to the aqueous medium, wherein the composition comprises a polycarboxylate polymer and/or a salt thereof.

In some embodiments, a method of the present disclosure may be carried out by treating a gas and/or liquid stream with an effective amount of a composition as described herein. The methods may be carried out in aqueous systems, oil systems and/or gas systems. For example, the compositions and methods may be used for dissolving iron sulfide deposits on heat exchanger surfaces. Certain methods may include applying a composition disclosed herein to a gas or liquid produced or used in the production, transportation, storage, and/or separation of crude oil or natural gas. In some embodiments, the compositions may be applied to a gas stream used or produced in a coal-fired process, such as a coal-fired power plant. In certain embodiments, the compositions may be applied to a gas or liquid produced or used in a waste-water process, a farm, a slaughter house, a land-fill, a municipality waste-water plant, a coking coal process, and/or a biofuel process.

The compounds and compositions disclosed herein may be added to an aqueous medium. The aqueous medium may comprise water, gas, and/or liquid hydrocarbon. In some embodiments, a compound or composition may be added to a liquid hydrocarbon. The liquid hydrocarbon can be any type of liquid hydrocarbon including, but not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, and any combination thereof. In some embodiments, the fluid or gas may comprise a refined hydrocarbon product.

A fluid or gas treated with a composition of the present disclosure may be at any selected temperature, such as ambient temperature or an elevated temperature. The fluid (e.g., liquid hydrocarbon) or gas may be at a temperature of from about 40° C. to about 250° C. In some embodiments, the fluid or gas may be at a temperature of from about −50° C. to about 300° C., about 0° C. to about 200° C., about 10° C. to about 100° C., or about 20° C. to about 90° C. For example, the fluid or gas may be at a temperature of about −20° C., about −15° C., about −10° C., about −5° C., or about 0° C. In certain embodiments, the fluid or gas can be found in an arctic environment and can have a temperature and salinity typical of such an environment.

The compositions of the disclosure may be added to a fluid at various levels of water cut. For example, the water cut may be from about 0% to about 100% volume/volume (v/v), from about 1% to about 80% v/v, or from about 1% to about 60% v/v. The fluid may be an aqueous medium that contains various levels of salinity. For example, the fluid may have a salinity of about 0% to about 25%, about 1% to about 24%, or about 10% to about 25% weight/weight (w/w) total dissolved solids (TDS).

The fluid and/or gas to which the compositions of the disclosure are introduced can be contained in and/or exposed to many different types of devices. For example, the fluid and/or gas may be contained in a device or apparatus that transports fluid or gas from one point to another, such as an oil and/or gas pipeline. The device or apparatus can be part of an oil and/or gas refinery, such as a pipeline, a separation vessel, a dehydration unit, or a gas line. The compositions can be introduced to large diameter flow lines of from about 1 inch to about 4 feet in diameter, small gathering lines, small flow lines and headers. The fluid can be contained in and/or exposed to an apparatus or device used in oil extraction and/or production, such as a wellhead. The device or apparatus may be part of a coal-fired power plant. The device or apparatus may be a scrubber (e.g., a wet flue gas desulfurizer, a spray dry absorber, a dry sorbent injector, a spray tower, a contact or bubble tower, or the like). The device or apparatus may be a cargo vessel, a storage vessel, a holding tank, or a pipeline connecting the tanks, vessels, or processing units.

The compositions may be introduced into a fluid or gas by any appropriate method for ensuring dispersal through the fluid or gas. In some embodiments, a composition may be added to the hydrocarbon fluid before the hydrocarbon fluid contacts a surface in the system. The composition may be added at a point in a flow line upstream from the point at which iron sulfide is to be dissolved. The compositions may be injected/added using mechanical equipment, such as chemical injection pumps, piping tees, injection fittings, atomizers, quills, and the like. In certain embodiments, the compositions of the disclosure may be pumped into an oil and/or gas pipeline using an umbilical line. In other embodiments, a capillary injection system may be used to deliver the composition to a selected fluid.

The compositions may be injected into a stream as an aqueous or non-aqueous solution, a mixture, or a slurry. The compositions may be applied to a fluid or gas to provide any selected concentration of components. For example, the composition may be added to a flow line to provide an effective treating dose of the desired component, such as iron sulfide dissolver, from about 0.01 ppm to about 50,000 ppm. The compositions may be applied to a fluid or gas to provide a concentration of iron sulfide dissolver of, for example, about 1 ppm to about 50,000 ppm, about 1 ppm to about 40,000 ppm, about 1 ppm to about 30,000 ppm, about 1 ppm to about 20,000 ppm, about 1 ppm to about 10,000, about 1 ppm to about 5,000 ppm, about 1 ppm to about 1,000 ppm, about 10 ppm to about 5,000 ppm, about 25 ppm to about 5,000 ppm, or about 50 ppm to about 5,000 ppm.

In accordance with the methods disclosed herein, the composition may be applied continuously, in batch, or a combination thereof. For example, a dosage rate for continuous treatment may range from about 10 ppm to about 500 ppm or about 10 ppm to about 200 ppm. A dosage rate for batch treatments may range from, for example, about 10 ppm to about 400,000 ppm or about 10 ppm to about 20,000 ppm. The composition can also be applied as a pill to a pipeline, for example, to provide a high dose (e.g., about 20,000 ppm) of a component, such as iron sulfide dissolver, of the composition.

The foregoing may be better understood by reference to the following examples, which are intended for illustrative purposes and are not intended to limit the scope of the disclosure or its application in any way.

### EXAMPLES

The ability of various polycarboxylate polymers (Formulae 1-7 above) to dissolve iron sulfide was determined by measuring solubilized Fe after dosing samples containing a suspension of iron-sulfide (about 30 ppm) treated with a set of anionic polymers. The solubilization tests were conducted using four different water compositions. Evaluations were conducted at a test temperature of about 65° C. for about 30 minutes.

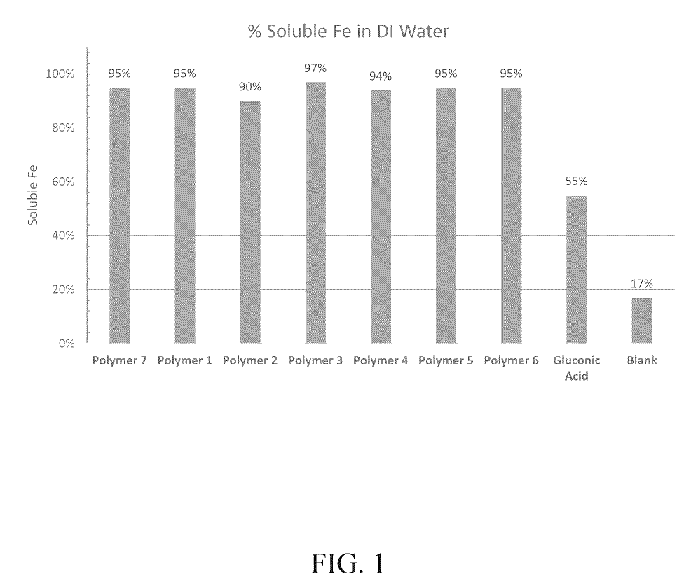

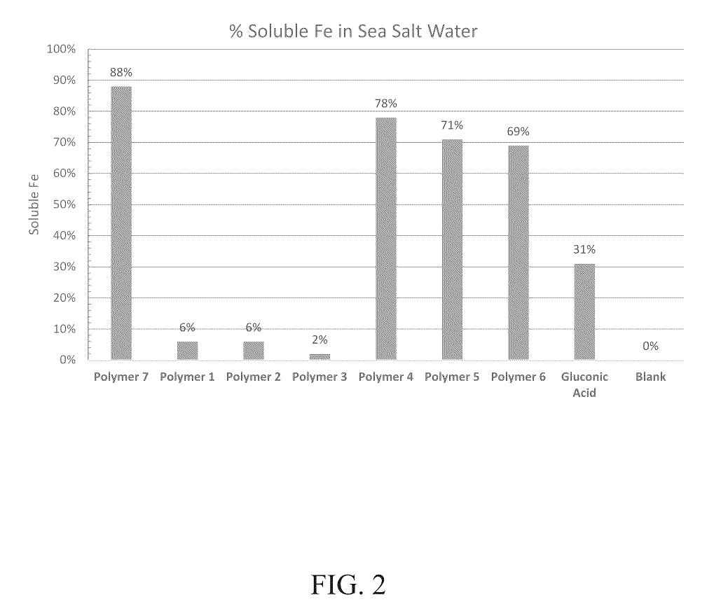

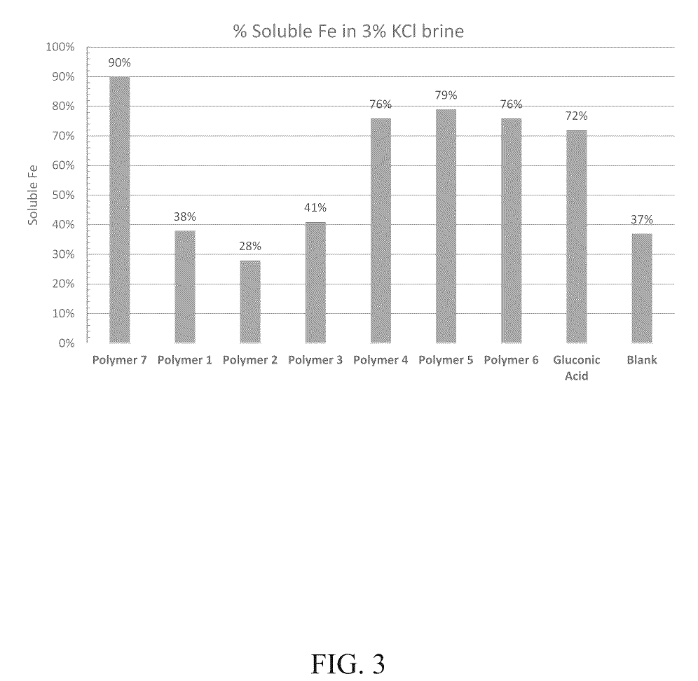

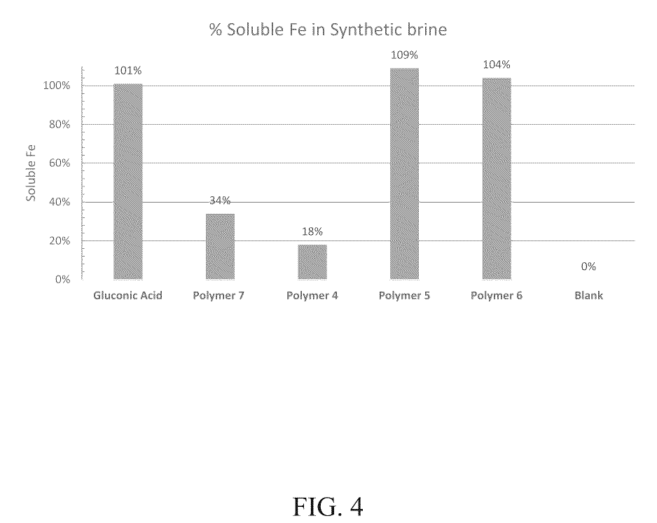

The iron sulfide solubilization performance of polycarboxylate polymers at about 100 ppm dosage was determined and are reported as percent (%) solubilized Fe. The results are shown in FIGS. 1-4.

As can be seen, Formula 7, Formula 4, Formula 6, and Formula 5 perform well in DI water, water compositions containing salts, and generally better than gluconic acid. Fully neutralized polycarboxylate polymers (Formula 1, Formula 2, Formula 3) only performed well in DI water. The results indicate that appropriate polycarboxylate polymers may be selected based on the composition of water being treated.

The synthetic brine included about 5.64 g of calcium chloride (CaCl₂), about 7.2 g of magnesium chloride (MgCl₂), about 1.32 g of potassium chloride (KCl), about 0.96 g of sodium sulfate (Na₂SO₄), about 16.8 g of sodium bicarbonate (NaHCO₃), about 205.8 g of sodium chloride (NaCl), about 1.08 g of sodium bromide (NaBr), about 10.8 g acetic acid and about 12 L of demineralized water.

The second aqueous solution included about 3.5% (w/w) of sea salts in demineralized water.

The third solution included about 3.0% (w/w) of KCl in demineralized water. Finally, deionized water was used.

The solutions were incubated at about 65° C. To each solution, iron chloride and sodium sulfide were added to afford an aqueous iron sulfide composition of about 30 ppm.

One mole of ferrous chloride (FeCl₂) was reacted with one mole of sodium sulfide (Na₂S) to produce one mole of iron sulfide (FeS) suspended in deionized water. The FeS composition containing approximately 30 ppm Fe was maintained at about 65° C. for about 10 minutes after which candidate FeS dissolvers were introduced at about 250 ppm and about 500 ppm. The treated samples were returned to the hot water bath for a 30-minute heating cycle. Then, the treated samples were removed from the hot water bath and allowed to cool to room temperature for 2 to 4 hours. After, the samples were shaken to ensure resuspension of the FeS. The suspensions were filtered through a 0.2 μm filter with solubilized iron captured in the water phase and submitted for analysis of the filtered residue by Inductively Coupled Argon Plasma Analysis. In addition to the candidate treated samples, an untreated sample of the FeS suspension was included for analysis, which served as the control sample (Blank).

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of dissolving an iron sulfide deposit in an aqueous medium, comprising:
adding a composition comprising a polycarboxylate polymer to the aqueous medium, and
dissolving at least a portion of the iron sulfide deposit.

2. The method of claim 1, wherein the composition comprises about 0.1 wt. % to about 60 wt. % of the polycarboxylate polymer.

3. The method of claim 1, wherein the polycarboxylate polymer is an acrylic acid homopolymer, an acrylic acid copolymer, a maleic acid homopolymer, a maleic acid copolymer, or any combination thereof.

4. The method of claim 1, wherein the polycarboxylate polymer is a copolymer comprising acrylic acid and maleic acid.

5. The method of claim 1, wherein the polycarboxylate polymer is at least partially neutralized.

6. The method of claim 1, wherein the polycarboxylate polymer is phosphonate terminated.

7. The method of claim 1, further comprising increasing a soluble iron percentage in the aqueous medium.

8. The method of claim 1, wherein the aqueous medium comprises a chloride-containing salt, sodium bicarbonate, sodium bromide, or any combination thereof.

9. The method of claim 1, wherein the aqueous medium comprises water, a gas, a liquid hydrocarbon, or any combination thereof.

10. The method of claim 1, wherein the composition further comprises an additive selected from the group consisting of an asphaltene inhibitor, a solvent, a paraffin inhibitor, a scale inhibitor, an emulsifier, a water clarifier, a dispersant, an emulsion breaker, a hydrogen sulfide scavenger, a gas hydrate inhibitor, a biocide, a pH modifier, an antifoam, a surfactant, a chelating agent, a hydroxycarboxylic acid, a sugar acid, malic acid, a corrosion inhibitor, and any combination thereof.

11. The method of claim 1, wherein a surface in contact with the aqueous medium comprises the iron sulfide deposit.

12. The method of claim 1, wherein the composition consists of or consists essentially of the polycarboxylate polymer.

13. The method of claim 1, wherein the composition consists of or consists essentially of the polycarboxylate polymer and the additive.

14. The method of claim 1, wherein the composition consists of or consists essentially of the polycarboxylate polymer and the solvent.

15. The method of claim 1, further comprising adding the polycarboxylate polymer at a concentration of about 5 ppm to about 20,000 ppm.

16. A method of dissolving an iron sulfide deposit in an aqueous medium, comprising:
providing a composition comprising about 0.1 wt. % to about 60 wt. % of a polycarboxylate polymer;
adding the composition to the aqueous medium, the aqueous medium comprising water, a gas, a liquid hydrocarbon, or any combination thereof, wherein a surface in contact with the aqueous medium comprises the iron sulfide deposit; and
dissolving at least a portion of the iron sulfide deposit.

17. The method of claim 16, wherein the polycarboxylate polymer is an acrylic acid homopolymer, an acrylic acid copolymer, a maleic acid homopolymer, a maleic acid copolymer, or any combination thereof.

18. The method of claim 16, wherein the polycarboxylate polymer is phosphonate terminated or at least partially neutralized.

19. The method of claim 16, wherein the aqueous medium comprises a chloride-containing salt, sodium bicarbonate, sodium bromide, or any combination thereof.

20. The method of claim 16, wherein the composition consists of or consists essentially of the polycarboxylate polymer.
